(19) United States
(12) Patent Application Publication
(10) Pub. No.: US 2015/0057023 A1
(43) Pub. Date: Feb. 26, 2015

(54) METHOD FOR DELIVERING A 'LOCALISED' MESSAGE TO A TERMINAL OF A RECIPIENT USER, AND ASSOCIATED PROCESSING METHOD, DEVICES AND COMPUTER PROGRAMS

(71) Applicant: Orange, Paris (FR)

(72) Inventors: Frederic Evennou, Lyon (FR); Amaud Ruffin, Grenoble (FR); Pierre Madillo, Vourey (FR)

(21) Appl. No.: 14/389,667

(22) PCT Filed: Mar. 28, 2013
(86) PCT No.: PCT/FR2013/050675

§ 371 Date: Sep. 30, 2014

(30) Foreign Application Priority Data
Mar. 30, 2012 (FR) 1252926

(51) Int. Cl. H04W 4/02

(52) U.S. Cl. CPC H04W 4/021
USPC 455/456.3

(57) ABSTRACT

A method delivers at least one “localized” message associated with a delivery area to a recipient using a terminal, which has first and second elements for localizing the terminal. The method includes: obtaining information representative of the delivery area associated with the localized message; obtaining a first localization area of the terminal using the first localization element; when an intersection between the first obtained localization area of the terminal and the geographical delivery area of the message is not empty, obtaining a second localization area of the terminal, which is more accurate than the first; delivering the content, when an intersection between the second obtained localization area of the terminal and the geographical delivery area of the message is not empty; and deactivating the second localization element when the delivery area of the message and the first localization area of the terminal have an empty intersection.

### 1. CROSS-REFERENCE TO RELATED APPLICATIONS

This application is a Section 371 National Stage Application of International Application No. PCT/FR2013/050675, filed Mar. 28, 2013, the content of which is incorporated herein by reference in its entirety, and published as WO 2013/144515 on Oct. 3, 2013, not in English.

### 2. FIELD OF THE INVENTION

The field of the invention is that of mobile or wireless networks, more specifically that of transmitting a message to a recipient user terminal according to the localization thereof.

### 3. BACKGROUND

A ‘localized’ or ‘geolocalized’ message is a message, generally short, of the SMS (Short Message Service, in English), MMS (Multimedia Message Service, in English) or other type, optionally including multimedia contents of the image, sound, photo or video type, with which a geographical delivery area is associated. Such a message is therefore intended to be delivered to its recipient when the latter is localized in this area. As an example of application, it may include a list of errands to run, its geographical area encompassing the geographical position near the supermarket. The recipient user receives the message when he/she passes next to the supermarket.

The delivery of such a message to its recipient is based on this user's mobile terminal providing information relating to his/her localization. Today, mobile terminals are natively provided with means of localization, whether based on a GSM (Global System for Mobile Communication, in English) triangulation technology which gives rise to localization information the accuracy of which is several hundred meters or on a GPS (Global Positioning System, in English) technology the accuracy of which is of the order of a few tens of meters.

A system for transmitting such messages in a mobile network is known from the published American patent U.S. Pat. No. 7,813,743 B1. With reference to FIG. 1, a central server S on the one hand obtains from a participating user terminal UE_{B} information Z1 representative of its geographical localization, and on the other hand receives messages M from a participating user terminal UE_{A} to the terminal UE_{B}. Such messages include information representative of their geographical delivery area Z_{D}. When the central server S establishes that the recipient user terminal UE_{B} of the localized message M enters the delivery area Z_{D} of this message, it triggers the transmission of this message to the terminal UE_{B}.

It is clear that the participating terminals must permanently activate their means of localization, in order to be able to periodically provide geographical localization information updated in the central server S. In addition, the localization information Z₁ provided must be sufficiently accurate for enabling the server to determine with a reasonable margin of error whether or not the recipient terminal UE_{B} is in the delivery area of the message and, accordingly, deliver the localized message appropriately. In the document U.S. Pat. No. 7,813,743 B1, such an area is defined by a geographical position c₁ and an associated radius r₁, which corresponds to the localization error. In practice, this means that the participating terminal UE_{B} must permanently activate GPS type means of localization, which provide it with an indication of its localization with a localization error of the order of a few tens of meters.

A first drawback of such a system is that it is costly in resources, both for the network, which must carry the localization information of the participating terminals, and for the terminals, which keep their most accurate and most energy consuming means of localization permanently activated.

A second drawback of this system is that it is not very respectful of the privacy of participants whose slightest movement is tracked by the central server.

### 4. SUMMARY OF THE INVENTION

The invention relates to a method for delivering at least one ‘localized’ message to a recipient user of a terminal connected to a telecommunications network, such a message being associated with a delivery area, said mobile terminal including first and second means of localization of said terminal.

According to the invention, said method includes the following steps, implemented by the terminal of the recipient:
obtaining at least one piece of information representative of the delivery area associated with said at least one localized message;
obtaining a first localization area of the terminal of the user with the aid of the first means of localization of said terminal;
when an intersection between the first localization area of the terminal and the delivery area of said at least one message is not empty, obtaining a second localization area of the terminal, more accurate than the first,
delivery of the contents, when an intersection between the second localization area of the terminal obtained and the geographical delivery area of the message is not empty; and
deactivation of the second means of localization, when the delivery area of said at least one message and the first localization area of the terminal present an empty intersection.

With the invention, the method for delivering a localized message is implemented in the terminal of the user. It follows that the localization information of the recipient terminal does not need to be transmitted to a central server of the telecommunications network. Bandwidth resources are thereby saved.

Accordingly, since the central server is no longer permanently informed of the localization of the user, the latter's privacy is thereby better respected.

Thus, the invention is based on an entirely novel and inventive approach to delivering a localized message to a recipient user terminal, whereby the decision of delivering the contents of a localized message to a recipient user is taken by the terminal of this user, according to the geographical localization of the user with respect to the delivery area associated with the message. Such an approach limits the exchanges with the server to a minimum and only informs it of the geographical position of the user when the latter has entered the delivery area of the localized message intended for him/her.

When said intersection is not empty, said method includes a step of obtaining a second localization area of the terminal, more accurate than the first, and the delivery of the contents is implemented when an intersection between the second localization area of the terminal obtained and the geographical delivery area of the message is not empty.

Advantageously, the method for transmitting a localized message according to the invention is primarily based on a coarse means of localization of the terminal, e.g. of the GSM triangulation type, which is more sparing in terms of energy consumption, for assessing whether the recipient terminal of the localized message is close to the delivery area of this message. The second means of localization of the terminal, e.g. of the GPS type, are capable of providing a more accurate localization area of the terminal. Since they are much more costly in energy resources, they are only activated in the event of a positive assessment. The energy resources of the terminal are therefore conserved.

The method includes a step of deactivation of the second means of localization, when the delivery area of said at least one message and the first localization area of the terminal present an empty intersection.

Advantageously, the fine means of localization of the terminal are deactivated as soon as it is established that the terminal has moved away from the delivery area of the localized message and that there is no other message in the coarse localization area of the terminal. Thus, the energy resources of the terminal are saved.

According to another aspect of the invention, said at least one piece of information representative of the delivery area of said at least one message is obtained during a preliminary step of receiving at least one message header, including said information. By way of example, such information includes a geographical position and a radius, representative of a measurement error. The delivery area is in this case represented in the form of a disk.

Advantageously, only the header of the localized message, including the information representative of a delivery area associated with this message, is systematically transmitted to the terminal of the user by the central server. This enables not triggering any unnecessary transfer of the contents of the message, which are more voluminous and therefore more expensive in terms of bandwidth resources than those of the header, until it has been established that the user has entered the delivery area of this message.

According to one aspect of the invention, said method implements a step of requesting transfer of the contents of said at least one message from a central server to the terminal, when the intersection between the delivery area of the message and the second localization area of the terminal is not empty.

The transmission of the contents of the localized message to the terminal of the user is only requested from the central server when it has been established with a fine accuracy that the terminal of the user has entered the delivery area of the message. One advantage is to limit the transfer of more voluminous data, such as the contents of the message, to what is strictly necessary.

According to another aspect of the invention, said method implements a step of requesting transfer of the contents of said at least one message from a central server of the telecommunications network to the terminal, when the intersection between the delivery area of the message and the first localization area of the terminal is not empty.

The transmission of the contents of the localized message is requested from the central server as soon as it has been established with a coarse accuracy that the terminal of the user has entered the delivery area of the message. One advantage is that of anticipating the transfer of data in order to ensure that the message will be delivered appropriately to the user. Indeed, owing to the fact that the contents are already loaded in the terminal, this embodiment is more responsive and offers more guarantees regarding a delivery of the contents to the user when he/she is localized in the delivery area of the localized message. This is even more useful when the user is moving quickly.

According to yet another aspect, the step of obtaining at least one piece of information representative of the delivery area associated with said at least one localized message includes a step of obtaining a list including a plurality of headers of localized message intended for said user.

The advantage is that of grouping all the delivery areas of the localized messages intended for the user of the recipient terminal into the same message including said list. Thus, the user terminal retrieves all the delivery areas of the messages intended for the user in a single exchange with the server, which can be used to optimize the resources.

The invention also relates to a device for delivering a localized message including means for implementing the steps of the method that has just been described. This device may, of course, comprise different features relating to the method for delivering at least one localized message according to the invention.

Such a device is capable of being integrated into a user terminal, e.g. a mobile terminal, of the smartphone (in English) type.

The invention therefore also relates to a user terminal including the device for delivering a localized message that has just been described.

The invention also relates to a method for processing at least one localized message intended for a user of a mobile terminal connected to a telecommunications network. According to the invention, said method is intended to be implemented by a server of said network capable of receiving said at least one ‘localized’ message from a transmitting terminal connected to said network and including the following steps:
sending to said recipient mobile terminal at least one piece of information representative of a delivery area of said at least one ‘localized’ message;
upon reception of a request to transfer the contents from said terminal, transfer of the contents to the terminal.

Advantageously, such a method is implemented by a device intended to be integrated into a central server of the telecommunications network.

The invention therefore also relates to a device for processing at least one localized message capable of implementing the steps of a such a method. This device may, of course, comprise different features relating to the method for processing at least one localized message according to the invention.

The invention also relates to a central server of a telecommunications network including such a device for processing a ‘localized’ message.

The invention further relates to a system for managing at least one localized message, including such a central server and at least two user terminals that have just been described.

The invention also relates to a computer program comprising instructions for implementing a method of processing as previously described, when this program is executed by a processor. Such a program may use any programming language. It may be downloaded from a communications network and/or recorded on a computer readable medium.

The invention finally relates to a computer program comprising instructions for implementing a method of management as previously described, when this program is executed by a processor. Such a program may use any programming language. It may be downloaded from a communications network and/or recorded on a computer readable medium.

### 5. LIST OF FIGURES

Other advantages and features of the invention will appear more clearly on reading the following description of a particular embodiment of the invention, given as a simple, illustrative and non-restrictive example, and accompanying drawings, in which:

FIG. 1 schematically illustrates an example of a mobile communications network implementing a service for delivering localized messages according to the prior art;

FIG. 2 schematically depicts an example of a mobile network implementing a service for delivering localized messages according to a first embodiment of the invention;

FIG. 3 schematically depicts an example of a mobile network implementing a service for delivering localized messages according to a second embodiment of the invention;

FIG. 4 schematically depicts the steps of the method for delivering at least one localized message according to one embodiment of the invention;

FIG. 5 schematically depicts the steps of the method for processing a localized message according to one embodiment of the invention;

FIG. 6 schematically depicts the exchanges of messages between a user, a terminal of the user and a localized message server according to the invention;

FIG. 7 schematically depicts an example of structure of a device for delivering at least one localized message according to the invention; and

FIG. 8 schematically depicts an example of structure of a device for processing at least one localized message according to the invention.

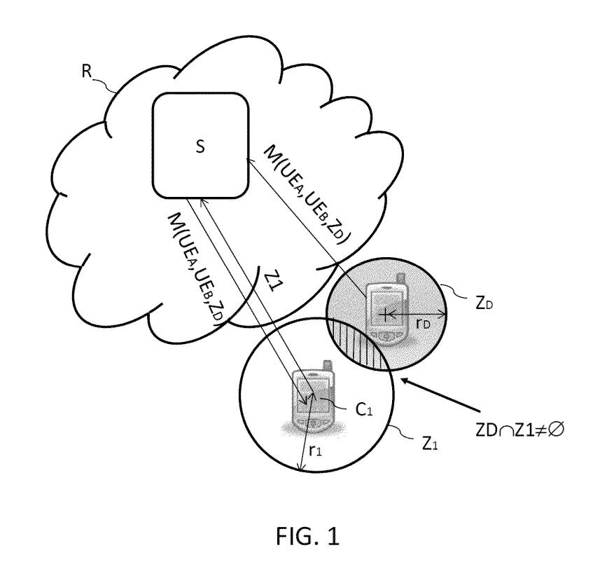

### 6. DESCRIPTION OF A PARTICULAR EMBODIMENT OF THE INVENTION

The general principle of the invention is based on a terminal of a user monitoring the delivery of the contents of a localized message intended for this user for optimizing the use of the resources of this terminal and of the telecommunications network to which the latter is connected.

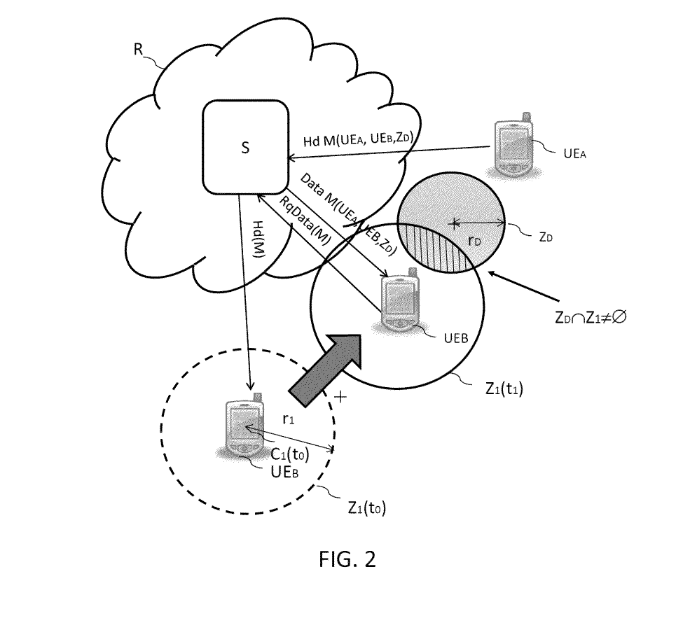

With reference to FIG. 2, a mobile telecommunications network R is considered, e.g. of the GSM type, compliant with versions 2G, 3G, 4G and following the 3GPP standard, or a WIFI type of wireless access network to an IP telecommunications network or finally a wireless telecommunications network compliant with any other standard and capable of implementing a service for depositing and delivering localized messages according to the invention. In this example, two user terminals UE_{A} and UE_{B} participate in the service.

The network R includes a server S capable of processing a localized message M intended for the user terminal UE_{B} and deposited by the terminal UE_{A}. This localized message M is associated with a geographical delivery area Z_{D}, that has been represented here, by way of a non-restrictive example, in the form of a disk with center C_{D} and radius r_{D}. It will be noted that this geographical area Z_{D} does not necessarily correspond to the localization of the terminal UE_{A} at the instant that it deposits the message M.

The message M includes a header HD and useful data Data. The header HD includes information relating to the recipient user terminal UE_{B}, such as, for example, an IP address or a phone number and information representative of the delivery area Z_{D} of the message M, such as the geographical coordinates of the center C_{D} and the radius r_{D}.

The terminals UE_{A} and UE_{B} are mobile terminals, e.g. of the smartphone or tablet type, which intrinsically have means of geographical localization. Conventionally, such means are capable of delivering a geographical position, with an accuracy that depends on the technique used.

At an instant t₀, the user terminal UE_{B} is localized in an area Z₁(t₀) centered on the position C₁(tₒ) and of radius r₁(t₀) corresponding to the accuracy of the technique used. This area Z₁ has an empty intersection with the localization area Z_{D} of the message M. The terminal UE_{B} therefore does not deliver the message to the user B thereof.

At an instant t₁, the user terminal UE_{B} has moved into an area Z1(t₁) centered on the position C1(t₁) and of radius r1(t₁). This area Z1(t₁) now has a non-empty intersection with the delivery area ZD associated with the message M. The terminal UEB then triggers the delivery of the useful data of the message M to the user thereof. For this purpose, it sends a request RqData(M) to the server S with a view to obtaining the useful data of the message M, then, once it has received them it presents them to the user B.

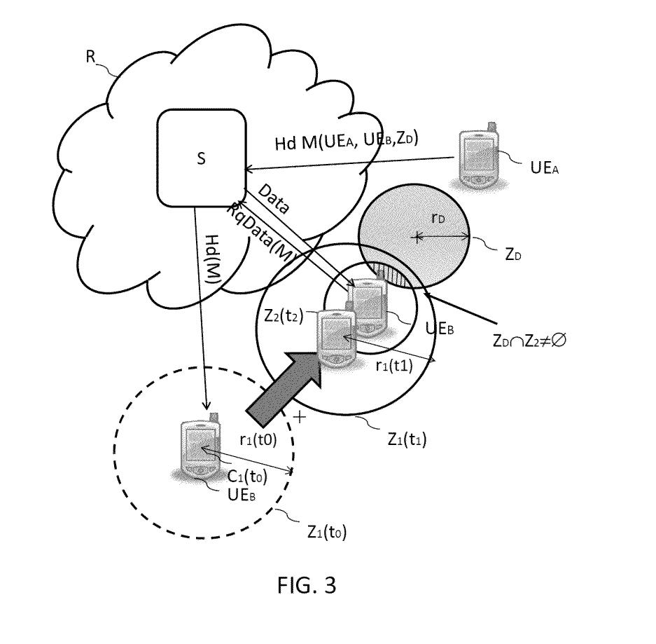

With reference to FIG. 3, another example of implementation of the invention in the network R is now described. In this example it is considered that the user terminal UE_{B} includes at least two means of geographical localization, first means capable of providing information representative of a coarse localization area Z₁ of the terminal and second means capable of providing information representative of a fine localization area Z₂ of the terminal. For example, the first means of localization use a GSM triangulation technique and the second means of localization are based on a GPS type technique.

The user terminal UE_{B}, when it participates in the service of delivering localized messages, begins by activating its coarse means of localization. As in the previous example, it obtains in t₁ a localization area Z₁(t₁) which has a non-empty intersection with the delivery area Z_{D} of the message M. According to this embodiment of the invention, it then triggers its fine means of localization, which provide it at instant t₂ with a localization area Z₂(t₂). It then checks that the intersection between this area Z₂(t₂) and the delivery area Z_{D} of the message M is not empty. If such is the case, it requests the contents of the message M from the server S and presents them to the user.

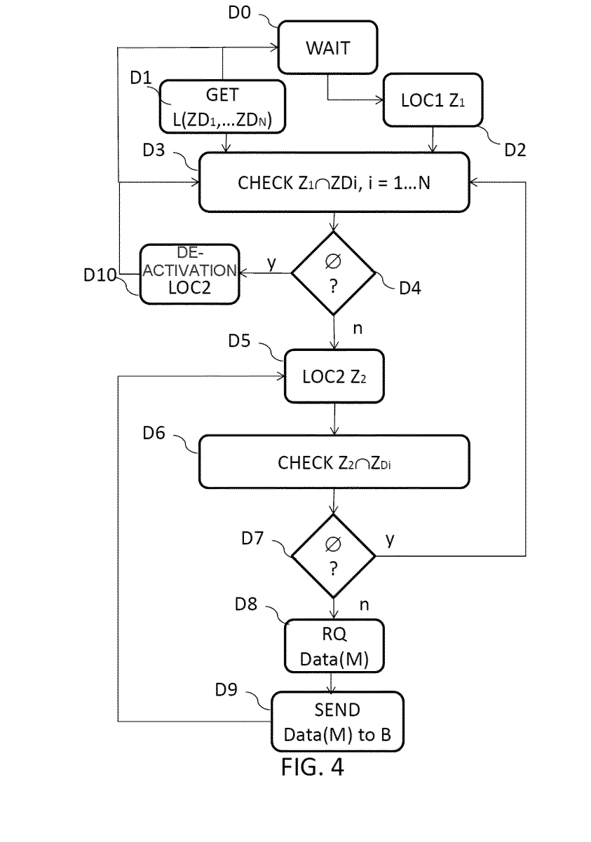

With reference to FIG. 4, a description is now given of the steps of the method for delivering a localized message to a user terminal according to one embodiment of the invention.

Advantageously, this method is implemented by a user terminal, e.g. the terminal UE_{B}. It is assumed that the user of the terminal UE_{B} is connected to the service, e.g. by launching a software application on his/her terminal. The launching of this application could trigger the opening of a permanent connection between the terminal UE_{B} and the server S.

Once the connection is established, the method then begins a first step D0 of waiting for a trigger event.

Such a trigger event notably includes:
The deposit Evt1 by at least one other connected user terminal of at least one message intended for the user of the terminal UE_{B};
The deposit by user B of at least one message intended for another user, e.g. user A of the terminal UE_{A};
stoppage of the service by user B.

It is assumed that the trigger event is the deposit by another user connected to the service, e.g. user A, of at least one message M intended for user B.

During a step D1, the terminal UE_{B} obtains from the server S at least the localization area Z_{D} associated with the message M.

It may receive the complete message M from the server S or only the header HD(M) of this message including the information relating to the geographical localization area Z_{D} associated therewith.

When connecting to the server S, the terminal UE_{B} may also receive a list L of information relating to the localization areas ZD₁ to ZD_{N} of a plurality of localized messages M₁ to M_{N}, with integer N greater than or equal to 2, which are intended therefor. In what follows, the current message will be designated by Mi, i being an integer between 1 and N.

Following step D1, the terminal UE_{B} activates in D2 its first means of localization LOC₁ with a view to obtaining a first geographical area Z₁ representative of a coarse localization of the terminal UE_{B}.

During a step D3, it determines for each message M, an intersection between the delivery area Z_{Di} associated with this message and its own coarse localization area Z₁.

If the determined intersection is empty for all the messages in the list received, the terminal UE_{B} decides in D4 to return to waiting D0 for a new trigger event. The trigger events include, at this stage, in addition to the events listed previously, obtaining Evt2 a new coarse localization area Z₁ at a following instant. In the latter case, the terminal UE_{B} repeats the implementation of steps D3 and D4 of the method according to the invention.

If, on the contrary, the determined intersection is not empty, the terminal UE_{B} activates in D5 its second means of localization LOC₂ with a view to obtaining a second geographical area Z₂ representative of a fine localization of the terminal.

During a step D6, it determines for each message M₁ to M_{N} an intersection between the delivery area Z_{Di} associated with this message and its fine localization area Z₂.

If the determined intersection is not empty for at least one message Mᵢ, the terminal UE_{B} decides in D7 to trigger the delivery of the contents of the message Mᵢ, i.e. its useful data Dataᵢ to the user,

If in D1 it has only received the header HDᵢ of the message Mᵢ, it first requests, in D8 the transfer of the useful data Dataᵢ of this message from the server S. This transfer is advantageously carried out via the permanent connection established with the server S when launching the application on the terminal UE_{B}.

Once the message is presented to the user, the terminal UE_{B} sends a message Ack(Mᵢ) of acknowledgment to the server S, so that the latter can mark this message M, as read or else delete it from its database.

If the intersection determined in D6 is empty for all the messages in the list received, the terminal as in the previous case waits in D0 for a new trigger event.

It is assumed that the next trigger event is obtaining an update Evt₂ of the coarse localization information Z₁. In this case, the terminal UE_{B} again implements steps D3 and D4 of the method for the list of messages M₁ to M_{N} obtained. If none of the messages received is in the coarse localization area Z₁ of the terminal UE_{B}, the terminal UE_{B} deactivates in D10 its second means of localization.

According to one variant of the embodiment that has just been described, the terminal UE_{B} triggers the transfer D8 of the contents of the message Mᵢ as soon as it has established that this message Mᵢ is in its coarse localization area Z₁, i.e. at the conclusion of step D4. It then only presents them to the user when the intersection between the fine localization area Z₂ of the terminal and the delivery area Z_{Di} of the message Mᵢ is not empty.

In the meantime, the useful data Dataᵢ are stored in a memory of the terminal UE_{B}. They are then loaded into a RAM memory of the terminal upon simple internal request to this memory then returned to the user on means of return integrated into the terminal, e.g. display means such as a screen.

One advantage of this variant is for the terminal to make sure of having the contents of the message Mi at its disposal as soon as it enters the localization area ZD of this message. Thus, it is protected against any risk of late delivery of a message that has become obsolete because of very rapid movement of user B, who is, for example, on board a motor vehicle.

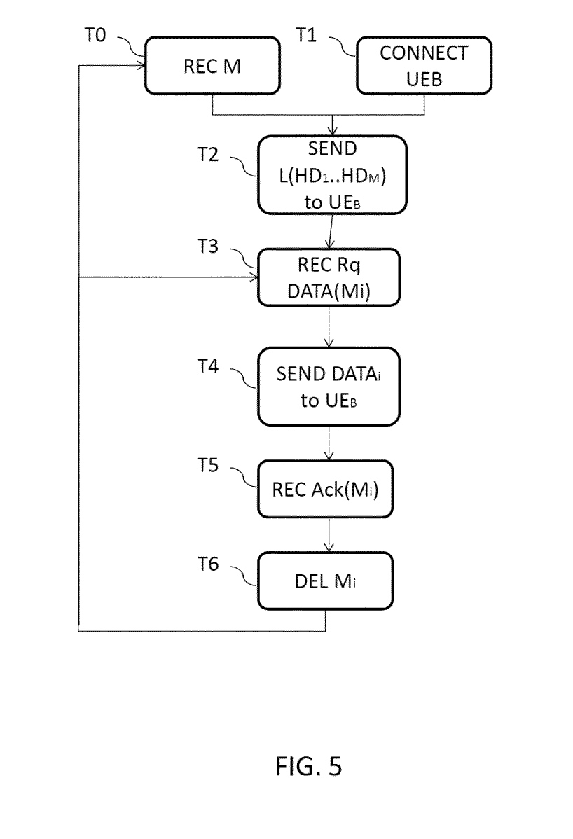

With reference to FIG. 5, a description is now given of the steps of the method for processing a localized message according to the invention. Such a method is advantageously implemented by the central server S.

It is assumed that the server S has received in a preliminary step T0 one or more localized messages M₁ to M_{N} with integer N greater than or equal to 1 from one or more user terminals UE_{A} and intended for the user terminal UE_{B}.

Upon reception of a connection request from the user terminal UE_{B} of the communications network R, the server S creates a connection in T1 with the requesting terminal UE_{B}. As soon as the connection is established, it sends to the terminal UE_{B}, during a step T2, a list including at least the localization areas Z_{D1} to Z_{DN} associated with the localized messages deposited by other user terminals, such as UE_{A} and intended for user B.

As already mentioned, the list L may include information relating to one or more localized messages M₁ to M_{N}, with integer N greater or equal to 2. This information may include the message or messages M₁ to M_{N} in their entirety, i.e. for a message Mᵢ, i an integer between 1 and N, its header H_{Di} and useful data Dataᵢ, or, according to a variant, only its header H_{Di} including the associated localization area Z_{Di}. One advantage of the list of headers is its relatively small size, which makes it inexpensive to transmit to the terminal, the contents or useful data of the localized messages in this list only being actually transferred when the recipient user terminal UE_{B} enters their respective localization areas Z_{Di}.

In the rest of the description of this example, we will consider the case of this variant.

In T3, the server S receives from the user terminal UEB a request Req Datai to transfer user data associated with a localized message Mi forming part of the list L. In T4, it sends it the useful data of the message via the connection established with this user UEB terminal in order that it can present the contents of the message Mᵢ to its user B. It marks the message Mᵢ as read in the list L.

In T5, the server S receives a message Ack(Mi) of acknowledgment from the user terminal UE_{B}. In T6, it may also mark the message in question Mi as read and optionally delete it from its database BD.

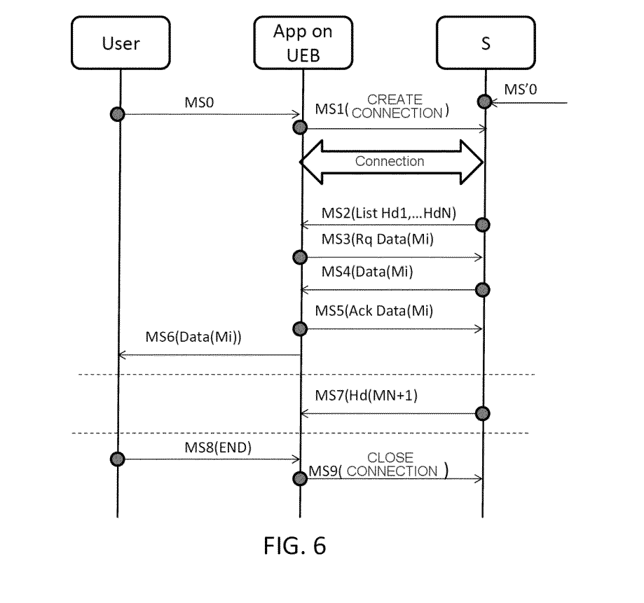

With reference to FIG. 6, a description is now given of an example of message exchange between user B, the terminal UE_{B} and the server S according to one embodiment of the invention.

User B starts the service on his/her terminal UE_{B}, e.g. by launching a software application with the aid of an action MS₀ on an interface, e.g. a touch-sensitive one on its terminal UE_{B}. Once launched, this application transmits a connection request to the server S, in the form of a message MS₁. The application of the terminal UE_{B} then waits for a trigger event, including at least:
the reception of one or more headers of localized messages from the server S, including the localization area or areas associated with these messages;
the entry of the user into a localization area received;
the request to stop the application by user B.

The server S creates a permanent connection identified by an identifier of user B. It then consults its database with a view to obtaining a list of localized messages M₁ to M_{N} that are unread and intended for user B, which have been deposited for him/her since the last connection of this user, e.g. in one or more messages MS′0. It then sends the list L obtained to the terminal UE_{B} in a message MS₂. This list includes at least the localization areas Z_{D1} to Z_{DN} associated with messages M1 to M_{N}.

Otherwise, if it has not received anything beforehand, it waits to receive localized messages intended for user B.

In what follows, the case is considered in which the server S has previously received a list L.

1—Reception of a List L of Headers of Localized Messages

The reception of the list L of the message MS2 by the terminal UE_{B} triggers the activation by the latter of its first means of localization LOC₁. With the localization Z₁ obtained, the application first roughly determines whether user B is in the localization area Z_{Di} of one of the localized messages Mᵢ in the list received. If this is the case, it activates the fine means of localization LOC₂ of the terminal UE_{B} for determining more precisely whether user B has actually entered the localization area Z_{Di} of the localized message Mᵢ in question. If this is the case, it sends in a message MS₃ a request to transfer the contents of the message to the server S via the established connection. It receives back a message MS₄ containing the useful data Dataᵢ requested and presents them to user B. The application acknowledges receipt of the contents of the message Mᵢ in a message MS5. It marks the message as read and then returns to waiting for another trigger event.

2—Updating the Coarse Localization Area of the Terminal

The reception of such an update triggers checking by the application of the new position of the terminal with respect to the localization areas of the localized messages received and not yet read.

If, on the basis of the updated localization area Z₁, the terminal is not close to any of the unread messages in the list, the application triggers the deactivation of the second localization means, which enables it to conserve the energy resources of the terminal UE_{B}. It then waits for a new trigger event.

3—Reception of a New Message M_{N+1} by the Server S

The server S, upon receiving a new localized message intended for the terminal UE_{B} notifies it of the arrival thereof by sending a message MS7 including its header H_{DN+1}.

The reception of the message MS7 triggers the implementation by the application of the steps of the method for delivering a localized message that have just been described.

4—Request to Stop the Application by the User

Upon receiving a request to stop the application by the user in MS8, the application deactivates the coarse and fine means of localization of the terminal, sends a disconnection message MS9 to the server S and stores the list of unread localized messages in memory. The server ends the permanent connection established with the terminal UE_{B}.

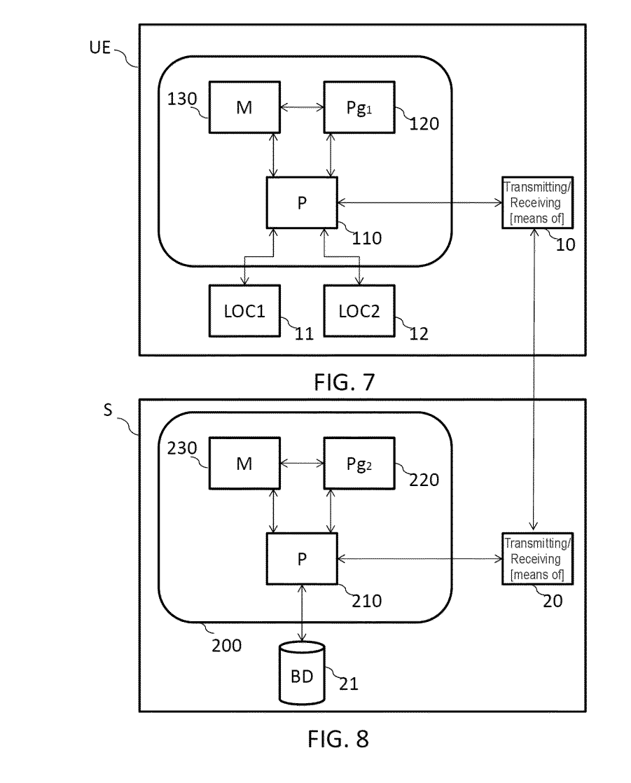

Finally, with reference to FIGS. 7 and 8, a description is given of the simplified structures of a device 100 for delivering a localized message according to the invention and a device 200 for processing a localized message according to the invention, respectively implementing a method of delivery and a method of processing according to one of the embodiments described above.

Advantageously, the device 100 is integrated into a mobile terminal UE according to the invention.

For example, the device 100 includes a processing unit 110, provided, for example, with a processor P, and controlled by a computer program Pg₁ 120, stored in a memory 130 and implementing the method for delivering a localized message according to the invention.

At initialization, the code instructions of the computer program Pg₁ 120 are, for example, loaded into a RAM memory before being executed by the processor of the processing unit 110. The processor of the processing unit 110 implements the steps of the method for delivering a localized message previously described, according to the instructions of the computer program 120.

Conventionally, the terminal UE includes means 10 of transmitting/receiving communications signals over the communications network R, carrying messages, such as localized messages. It also includes first means 11 of localization LOC1, implementing, for example, a technique of localization by GSM triangulation and second means 12 of localization LOC₂ implementing, for example, a technique of localization by GPS. These means are controlled by the processor of the processing unit 110.

Advantageously, the processing unit 110 obtains according to the invention from the means of transmitting/receiving a list including at least the localization areas ZD associated with localized messages intended for the user. It activates the means of localization 11, 12 with a view to obtaining information representative of a fine or coarse area of localization of the terminal. It orders the means 10 of transmitting/receiving to transmit to the server S a request to transfer the contents of one of said localized messages, when it has determined that the user is in the localization area of this message.

Advantageously, the device 200 according to the invention is integrated into a central server S.

For example, the device 200 includes a processing unit 210, provided, for example, with a processor P, and controlled by a computer program Pg2 220, stored in a memory 230 and implementing the method for processing at least one localized message according to the invention.

At initialization, the code instructions of the computer program Pg2 220 are, for example, loaded into a RAM memory before being executed by the processor of the processing unit 210. The processor of the processing unit 210 implements the steps of the processing method previously described, according to the instructions of the computer program 220.

Conventionally, the server S includes means of transmitting/receiving 20 capable of transmitting and receiving communications signals carrying messages, such as localized messages, in the communications network R. It further includes means of storing 21 localized messages that it processes, such as, for example, a database BD.

According to the invention, these means are controlled by the processor of the processing unit 210. Advantageously, the processing unit 210 obtains from such means localized messages deposited by user terminals intended for other user terminals of the network R and it stores them in the database BD. It transmits to the recipient terminals, lists of localized message including at least the localization areas Z_{D} associated with these messages.

It also receives requests to transfer contents of these messages, to which it responds by querying its database BD with a view to obtaining the required messages and by sending their useful data to the requesting user terminals.

Of course other embodiments of the invention may be envisaged. For example, the invention may be implemented in an IP communications network to which the user terminals are connected via a WIFI type of wireless network.

1. A method for delivering at least one ‘localized’ message to a recipient user of a terminal connected to a telecommunications network, such a message being associated with a delivery area, said terminal of the recipient user being capable of localizing the terminal based on a first localization technique and a second localization technique, said method comprising the following steps, implemented by the terminal of the recipient user, said method comprising the following steps, implemented by the terminal of the recipient user:
obtaining at least one piece of information representative of the delivery area associated with said at least one localized message;
obtaining a first localization area of the terminal of the user with the aid of the first localization technique of said terminal;
when an intersection between the first localization area of the terminal and the delivery area of said at least one message is not empty, obtaining a second localization area of the terminal, more accurate than the first,
delivery of contents of the at least one message, when an intersection between the second localization area of the terminal obtained and the geographical delivery area of the message is not empty; and
deactivation of the second localization technique, when the delivery area of said at least one message and the first localization area of the terminal present an empty intersection.

2. The method for delivering a ‘localized’ message as claimed in claim 1, wherein said at least one piece of information representative of the delivery area of said at least one message is obtained during a preliminary step of receiving at least one message header, including said information.

3. The method for delivering a ‘localized’ message as claimed in claim 1, wherein said method implements a step of requesting transfer of the contents of said at least one message from a central server of the telecommunications network to the terminal, when the intersection between the delivery area of the message and the first localization area of the terminal is not empty.

4. The method for delivering a ‘localized’ message as claimed in claim 1, wherein said method implements a step of requesting transfer of the contents of said at least one message from a central server to the terminal, when the intersection between the delivery area of the message and the second localization area of the terminal is not empty.

5. The method for delivering a ‘localized’ message as claimed in claim 1, wherein the step of obtaining at least one piece of information representative of the delivery area associated with said at least one localized message includes a step of obtaining a list including a plurality of headers of localized message intended for said user.

6. A device for delivering a ‘localized’ message to a recipient user of a mobile terminal connected to a telecommunications network, said mobile terminal being capable of localizing the terminal based on a first localization technique and a second localization technique, said device comprising:
means for obtaining at least one piece of information representative of the delivery area associated with said at least one localized message;
means for obtaining a first localization area of the terminal of the user with the aid of the first localization capability of said terminal;
when an intersection between the first localization area of the terminal and the delivery area of said at least one message is not empty, obtaining a second localization area of the terminal, more accurate than the first,
delivery of the contents of the ‘localized’ message, when an intersection between the second localization area of the terminal obtained and the geographical delivery area of the message is not empty; and
deactivation of the second localization technique, when the delivery area of said at least one message and the first localization area of the terminal present an empty intersection.

7. A user terminal capable of being connected to a mobile telecommunications network and comprising the device as claimed in claim 6.

8. A method for processing at least one ‘localized’ message intended for a user of a mobile terminal connected to a telecommunications network, said method being implemented by a server of said network capable of receiving said at least one ‘localized’ message from a transmitting terminal connected to said network, wherein the method comprises:
sending to said recipient mobile terminal at least one piece of information representative of a delivery area of said at least one ‘localized’ message; and
upon reception of a request to transfer contents of the ‘localized’ message from said terminal, transferring of the contents to the terminal.

9. A device for processing at least one ‘localized’ message intended for a user of a mobile terminal connected to a telecommunications network, said device being implemented by a server of said network capable of receiving said at least one ‘localized’ message from a transmitting terminal connected to said network, wherein the device comprises:
means for sending to said recipient mobile terminal at least one piece of information representative of a delivery area of said at least one ‘localized’ message; and
upon reception of a request to transfer contents of the ‘localized’ message from said terminal, transferring the contents to the terminal.

10. A central server of a telecommunication network, the central server comprising the device as claimed in claim 9.

11. (canceled)

12. A non-transitory computer-readable medium comprising a computer program recorded thereon, which comprises instructions for implementing a method for delivering at least one ‘localized’ message to a recipient user of a terminal connected to a telecommunications network, such a message being associated with a delivery area, when the instructions are executed by a processor, said terminal of the recipient user being capable of localizing the terminal based on a first localization technique and a second localization technique, said method comprising the following steps, implemented by the terminal of the recipient user:
obtaining at least one piece of information representative of the delivery area associated with said at least one localized message;
obtaining a first localization area of the terminal of the user with the aid of the first localization technique;
when an intersection between the first localization area of the terminal and the delivery area of said at least one message is not empty, obtaining a second localization area of the terminal, more accurate than the first,
delivery of contents of the at least one message, when an intersection between the second localization area of the terminal obtained and the geographical delivery area of the message is not empty; and
deactivation of the second localization technique, when the delivery area of said at least one message and the first localization area of the terminal present an empty intersection.

13. A non-transitory computer-readable medium comprising a computer program recorded thereon, which comprises instructions for implementing a method for processing at least one ‘localized’ message intended for a user of a mobile terminal connected to a telecommunications network, when the instructions are executed by a processor, said method being implemented by a server of said network capable of receiving said at least one ‘localized’ message from a transmitting terminal connected to said network, wherein the method comprises:
sending to said recipient mobile terminal at least one piece of information representative of a delivery area of said at least one ‘localized’ message; and
upon reception of a request to transfer contents of the ‘localized’ message from said terminal, transferring the contents to the terminal.
